(19) United States
(12) Patent Application Publication
(10) Pub. No.: US 2025/0251017 A1
(43) Pub. Date: Aug. 7, 2025

(54) FLUID DYNAMIC BEARING AND FLUID DYNAMIC BEARING DEVICE INCLUDING SAME

(71) Applicant: NTN CORPORATION, Osaka (JP)

(72) Inventors: Masashi YAMAGOU, Mie (JP); Shinji KOMATSUBARA, Mie (JP); Fuyuki ITO, Mie (JP); Daichi KATO, Mie (JP)

(21) Appl. No.: 18/692,949

(22) PCT Filed: Sep. 6, 2022
(86) PCT No.: PCT/JP2022/033378

§ 371 Date: Aug. 30, 2024

(30) Foreign Application Priority Data
Sep. 27, 2021 (JP) 2021-156556

(51) Int. Cl. F16C 17/02

(52) U.S. Cl. CPC F16C 17/026

(57) ABSTRACT

In a bearing sleeve 8 (fluid dynamic bearing) including a cylindrical sintered body formed with dynamic pressure generating grooves G1 on an inner peripheral surface 8a, a ratio D2/D1 of an outer diameter D2 to an inner diameter D1 of the sintered body is 2.5 or less, and differences in relative density among three parts 8A, 8B, 8C defined by trisecting the sintered body in an axial direction are within 3%.

### TECHNICAL FIELD

The present invention relates to a fluid dynamic bearing and a fluid dynamic bearing device including the fluid dynamic bearing.

### BACKGROUND ART

A fluid dynamic bearing device is a device with which relative rotation between a bearing member and a shaft member inserted inside the inner periphery of the bearing member increases pressure of a fluid film formed in a radial bearing gap between the outer peripheral surface of the shaft member and the inner peripheral surface of the bearing member, and that, with this pressure (dynamic pressure action), supports the shaft member in a non-contact manner to allow the shaft member to be relatively rotatable. The fluid dynamic bearing device is suitably used for supporting a rotation shaft of a spindle motor of a disk drive device of an HDD, a polygon scanner motor of a laser beam printer, a fan motor for cooling an electronic device, or the like, because of its excellent rotation accuracy and quietness.

In the inner peripheral surface of the bearing member of the fluid dynamic bearing device, dynamic pressure generating grooves may be formed that actively increase the pressure of a lubricating fluid in the radial bearing gap. As a method for forming the dynamic pressure generating grooves, so-called dynamic pressure generating groove sizing is known in which the dynamic pressure generating grooves are die-formed on the inner peripheral surface of a cylindrical sintered body. In the dynamic pressure generating groove sizing, while a sizing pin is inserted inside the inner periphery of the sintered body, the sintered body is press-fitted inside the inner periphery of a die in a state of being pressed in the axial direction by an upper punch and a lower punch, whereby the inner peripheral surface of the sintered body is pressed against a forming die formed on the outer peripheral surface of the sizing pin. As a result, the shape of the forming die is transferred to the inner peripheral surface of the sintered body, and the dynamic pressure generating grooves are formed (see, for example, Patent Literature 1).

### CITATIONS LIST

### Patent Literature

Patent Literature 1: JP H11-182550 A

### SUMMARY OF INVENTION

### Technical Problems

In a fluid dynamic bearing device including a bearing member formed with dynamic pressure generating grooves on an inner peripheral surface thereof (hereinafter, this bearing member is referred to as a “fluid dynamic bearing”), it is known that dynamic pressure is most efficiently generated in a case where a ratio between the dynamic pressure generating groove depth and the width of a radial bearing gap is 1:1. In contrast, when the width of the radial bearing gap is small, there is a possibility that upon inclination of a shaft member with respect to the fluid dynamic bearing, the shaft member comes into contact with an axial end portion of the fluid dynamic bearing. Thus, it is necessary to reduce the risk of contact between the shaft member and the fluid dynamic bearing by increasing the dynamic pressure generating groove depth as much as possible to increase the width of the radial bearing gap while maintaining the ratio between the dynamic pressure generating groove depth and the width of the radial bearing gap at 1:1.

However, in a case where the dynamic pressure generating grooves are formed by pressing the inner peripheral surface of a sintered body against the sizing core as described above, a sufficient dynamic pressure generating groove depth cannot be secured if the amount of springback of the sintered body is insufficient. FIG. 6 illustrates a relationship between each of ratios D2/D1 of the outer diameter D2 to the inner diameter D1 of a sintered body, and a corresponding one of the dynamic pressure generating groove depths at a corresponding one of points. As can be seen from this graph, the dynamic pressure generating groove depth reduces as the inner-outer diameter ratio D2/D1 of the sintered body increases, that is, as the wall thickness of the sintered body in the radial direction increases. Therefore, in a case where the dynamic pressure generating groove depth is increased, it is preferable to reduce the inner-outer diameter ratio D2/D1 of the sintered body.

However, in a case where the inner-outer diameter ratio of the sintered body is reduced, the following problems occur in the dynamic pressure generating groove sizing. In the dynamic pressure generating groove sizing, the sintered body is compressed from both sides in the axial direction and the radially outer side. In a case where the inner-outer diameter ratio of the sintered body is large (that is, the wall thickness in the radial direction is large), rigidity against the compressive force in the axial direction is high. Thus, the compressive force from both sides in the axial direction is hardly transmitted to the inner peripheral surface of the sintered body, and the compression from the radially outer side becomes dominant. In contrast, in a case where the inner-outer diameter ratio of the sintered body is small (that is, the wall thickness in the radial direction is small), the rigidity against the compressive force in the axial direction is low. Thus, the compressive force in the axial direction is easily transmitted to the inner peripheral surface of the sintered body, particularly near both axial ends. As a result, density increases at the axial end portions of the sintered body, compared with the density at the center of the sintered body in the axial direction. In particular, the density of the sintered body tends to increase on the side of an upper punch with which the sintered body is pressed inside the inner periphery of a die (see FIG. 7).

As described above, when the density (that is, the compression ratio) of the sintered body varies depending on the axial position, the dynamic pressure generating groove depth increases in a portion of higher density, and the dynamic pressure generating groove depth reduces in a portion of lower density. Such variation in the dynamic pressure generating groove depth in the axial direction may lead to failure in obtaining desired bearing rigidity.

In addition, when the density (that is, the compression ratio) of the sintered body varies depending on the axial position, disturbance occurs in the generating line shape (profile in the axial cross section) of the inner peripheral surface of the sintered body, and the axially central portion with a low density protrudes toward the radially inner side, as illustrated in FIG. 8. As described above, when the disturbance occurs in the generating line shape of the inner peripheral surface, the width of the radial bearing gap varies in the axial direction. Thus, there is a possibility that desired bearing rigidity cannot be obtained.

Therefore, it is an object of the present invention to obtain desired bearing rigidity in a fluid dynamic bearing in which a dynamic pressure generating groove depth of a sintered body is increased.

### SOLUTIONS TO PROBLEMS

To achieve the above object, the present invention provides a fluid dynamic bearing including a sintered body having a cylindrical shape, the sintered body being formed with a dynamic pressure generating grooves on an inner peripheral surface of the sintered body, where a ratio D2/D1 of an outer diameter D2 to an inner diameter D1 of the sintered body is 2.5 or less, and where differences in relative density among three parts defined by axially trisecting the sintered body are within 3%.

In this manner, by reducing (to 2.5 or less) the inner-outer diameter ratio D2/D1 of the fluid dynamic bearing, that is, by reducing the wall thickness of the fluid dynamic bearing, it is possible to increase a dynamic pressure generating groove depth. By making the density of such a thin sintered body substantially uniform in the axial direction, specifically, by causing the differences in relative density among the three parts defined by trisecting the sintered body in the axial direction to fall within 3%, it is possible to reduce variation in the dynamic pressure generating groove depth caused by the differences in density in the axial direction of the sintered body, and it is possible to reduce disturbance in the generating line shape of the inner peripheral surface.

When the axial length of the sintered body is reduced to 4 mm or less, a compressive force in the axial direction applied to the sintered body at the time of forming the dynamic pressure generating grooves is easily transmitted to the entire axial area of the inner peripheral surface. Thus, it is possible to reduce variation in the density of the sintered body depending on axial positions.

By making the density of the sintered body substantially uniform in the axial direction as described above, it is possible to reduce shear droop (recession toward the radially outer side) at an axial end portion of the inner peripheral surface of the sintered body. Specifically, it is possible to reduce, to 2 μm or less, a difference between a radius of a smallest diameter portion and a radius of a largest diameter portion of an inner surface of a hill portion, rising radially inward with respect to the dynamic pressure generating grooves, on the inner peripheral surface of the fluid dynamic bearing.

It is difficult to make the density of the sintered body completely uniform in the axial direction, and thus density in an axially central portion of the sintered body is slightly lower than density in the axial end portions. Therefore, variation in the dynamic pressure generating groove depth is likely to occur, for each product, in the lower-density axially central portion of the fluid dynamic bearing. For this reason, the dynamic pressure generating grooves may be omitted in the axially central portion where the depth is likely to vary. At this time, for example, it is conceivable to provide a cylindrical surface without the dynamic pressure generating grooves in the axially central portion by providing the dynamic pressure generating grooves arranged in a herringbone pattern at two locations separated from each other in the axial direction.

However, in this case, the axial dimension of the fluid dynamic bearing increases, and thus it becomes difficult to make the density uniform in the axial direction.

Therefore, the cylindrical surface may be formed by omitting the dynamic pressure generating grooves on the axially central side among the dynamic pressure generating grooves arranged in a herringbone pattern provided at the two axial locations. Specifically, the inner peripheral surface of the sintered body may be formed with a pair of annular hill portions provided at two locations axially separated from each other, a plurality of inclined hill portions extending axially outward from the annular hill portions, the dynamic pressure generating grooves provided circumferentially between the plurality of inclined hill portions, and a cylindrical surface provided in an entire area axially between the pair of annular hill portions, the cylindrical surface having a diameter larger than each of respective inner diameters of the annular hill portions. As described above, by omitting the inclined hill portions and the dynamic pressure generating grooves in the axially central portion (the portion axially between the pair of annular hill portions) of the sintered body, it is possible to reduce variation in the dynamic pressure generating groove depth for each product, and it is possible to stabilize the performance of the fluid dynamic bearing.

A fluid dynamic bearing device includes the fluid dynamic bearing, a shaft member inserted inside an inner periphery of the fluid dynamic bearing, and a radial bearing portion configured to support the shaft member in a non-contact manner to allow the shaft member to be relatively rotatable, with dynamic pressure action of a lubricating film formed in a radial bearing gap between an inner peripheral surface of the fluid dynamic bearing and the shaft member. The fluid dynamic bearing device can stably support the shaft member.

### Advantageous Effects of Invention

As described above, by reducing the wall thickness of the sintered body in the radial direction, it is possible to increase the dynamic pressure generating groove depth, and by making the density of the sintered body substantially uniform in the axial direction, it is possible to reduce the variation in the dynamic pressure generating groove depth and the disturbance in the generating line shape of the inner peripheral surface. Therefore, it is possible to obtain desired bearing rigidity.

### BRIEF DESCRIPTION OF DRAWINGS

FIG. 1 is a cross-sectional view of a fan motor.

FIG. 2 is a cross-sectional view of a fluid dynamic bearing device.

FIG. 3 is a cross-sectional view of a fluid dynamic bearing according to an embodiment of the present invention.

FIG. 4A is a cross-sectional view for illustrating a sizing step, and illustrates a state before a sintered body is press-fitted into a die.

FIG. 4B is a cross-sectional view for illustrating the sizing step, and illustrates a state in which the sintered body is press-fitted into the die.

FIG. 5 is a cross-sectional view of a fluid dynamic bearing according to another embodiment.

FIG. 6 is a graph illustrating a relationship between each of inner-outer diameter ratios of a fluid dynamic bearing and a corresponding one of dynamic pressure generating groove depths.

FIG. 7 is a graph illustrating variation in density based on axial positions of a fluid dynamic bearing.

FIG. 8 is a diagram illustrating a generating line shape of an inner peripheral surface of a fluid dynamic bearing.

### DESCRIPTION OF EMBODIMENTS

Hereinafter, embodiments of the present invention will be described with reference to the drawings.

FIG. 1 conceptually illustrates an example of a fan motor. The fan motor illustrated in FIG. 1 is a device that is incorporated in a portable information device such as a laptop computer or a tablet terminal, and that generates an airflow for cooling a heat source such as a CPU. The fan motor includes a fluid dynamic bearing device 1, a motor base 5 forming a stationary side of the motor, a rotor 3 fixed to a shaft member 2 of the fluid dynamic bearing device 1, blades 4 attached to the rotor 3, and a stator 6a and a magnet 6b arranged to face each other across a radial gap. The stator 6a is attached to a housing 7 of the fluid dynamic bearing device 1, and the magnet 6b is attached to the rotor 3. When the coil of the stator 6a is energized, an electromagnetic force is generated between the stator 6a and the magnet 6b to cause the shaft member 2 and the rotor 3 fixed to the shaft member 2 to integrally rotate. With rotation of the rotor 3, an airflow is generated that flows axially or radially outward in accordance with the form or the like of the blades 4 attached to the rotor 3.

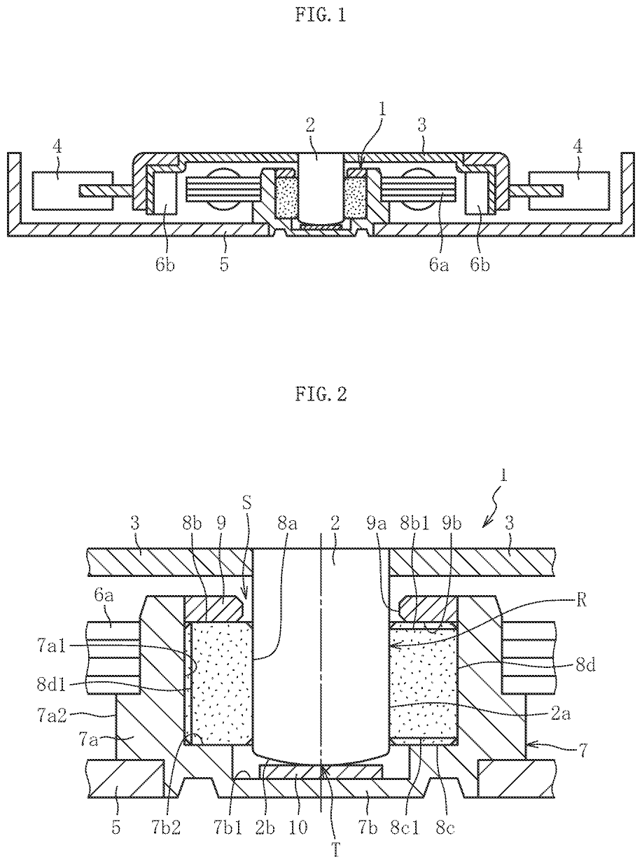

As illustrated in FIG. 2, the fluid dynamic bearing device 1 includes the shaft member 2, the housing 7, a bearing sleeve 8 serving as a fluid dynamic bearing according to an embodiment of the present invention, and a sealing member 9. The internal space of the housing 7 is filled with lubricating oil. In the following description, for convenience of description, a side toward which the shaft member 2 protrudes from the housing 7 in the axial direction (the upper side in FIG. 2) will be referred to as an “upper side”, and a side opposite thereto (the lower side in FIG. 2) will be referred to as a “lower side”. However, these terms are not intended to limit the orientation of the fluid dynamic bearing device 1 when being used.

The shaft member 2 is made of a highly rigid metal material such as stainless steel. The shaft member 2 has an outer peripheral surface 2a, on which a smooth cylindrical surface without unevenness is formed. The shaft member 2 also has a convex spherical surface 2b formed at the lower end thereof. The rotor 3 is fixed to the upper end of the shaft member 2.

The housing 7 includes a cylindrical portion 7a and a bottom portion 7b that closes a lower end opening of the cylindrical portion 7a. In the illustrated example, the cylindrical portion 7a and the bottom portion 7b are integrally formed of a resin or a metal material. A shoulder surface 7b2 disposed above an upper-side end surface 7b1 of the bottom portion 7b is provided around the outer periphery of the upper-side end surface 7b1. The stator 6a and the motor base 5 are fixed to an outer peripheral surface 7a2 of the cylindrical portion 7a.

In the illustrated example, a thrust plate 10 is provided on an inner bottom surface (upper end surface of the bottom portion 7b) 7b1 of the housing 7. The thrust plate 10 is formed of a material having slidability superior to the material forming the housing 7, and is formed in a disk shape. The convex spherical surface 2b at the lower end of the shaft member 2 is in contact with and supported by the upper end surface of the thrust plate 10. Note that the thrust plate 10 may be omitted, and in this case, the convex spherical surface 2b of the shaft member 2 is in contact with and supported by the inner bottom surface 7b1 of the housing 7.

The sealing member 9 is formed of resin or a metal material and formed in an annular shape, and is fixed to the upper end portion of an inner peripheral surface 7a1 of the cylindrical portion 7a of the housing 7. A lower end surface 9b of the sealing member 9 is in contact with an upper end surface 8b of the bearing sleeve 8. An inner peripheral surface 9a of the sealing member 9 forms an annular sealing space S between the inner peripheral surface 9a and the outer peripheral surface 2a of the shaft member 2 facing the inner peripheral surface 9a.

Note that the fluid dynamic bearing device 1 is of a so-called partial-fill type in which lubricating oil and air are mixed inside the housing 7. However, the fluid dynamic bearing device 1 is not limited thereto, and may be of a so-called full-fill type in which the entire internal space of the housing 7 is filled with lubricating oil. In the case of the full-fill type, the sealing space has a wedge shape in cross section, and the surface of lubricating oil is always held to be located within the axial range of the sealing space S.

The bearing sleeve 8 is, for example, a porous sintered body containing copper and iron as main components, and is formed in a cylindrical shape. The bearing sleeve 8 is fixed to the inner periphery of the housing 7 in an oil-impregnated state in which internal pores of the sintered body are impregnated with lubricating oil. In the illustrated example, the bearing sleeve 8 is fixed to the inner periphery of the cylindrical portion 7a of the housing 7 with a lower end surface 8c of the bearing sleeve 8 in contact with the shoulder surface 7b2 of the bottom portion 7b of the housing 7. The bearing sleeve 8 is fixed to the inner peripheral surface 7a1 of the cylindrical portion 7a by press-fitting, adhesion, press-fit adhesion (combination of press-fitting and adhesion), or the like. In addition to the above method, the bearing sleeve 8 can be fixed to the inner periphery of the cylindrical portion 7a by clearance-fitting the bearing sleeve 8 to the inner periphery of the housing 7, and then by sandwiching the bearing sleeve 8 between the sealing member 9 and the shoulder surface 7b2 of the housing 7 from both sides in the axial direction.

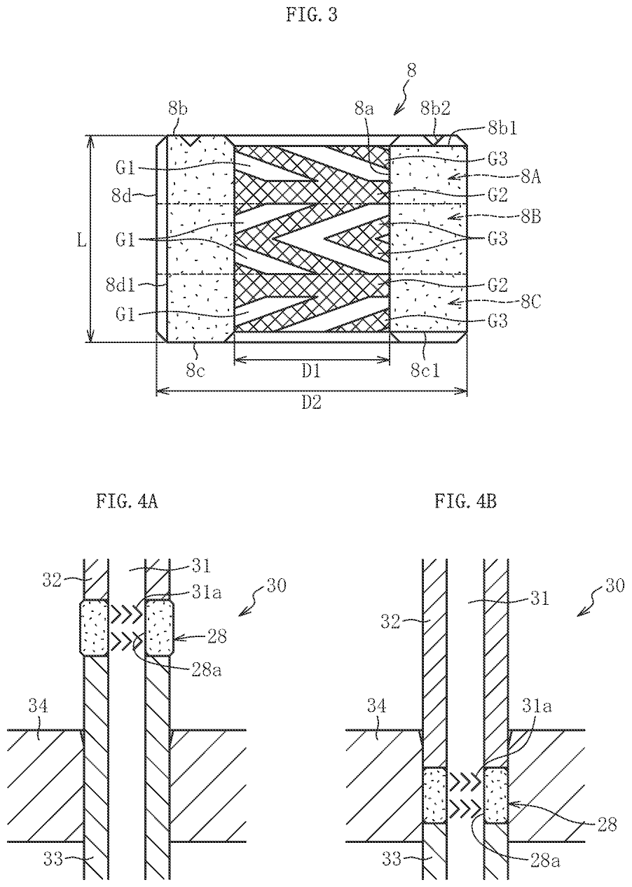

As illustrated in FIG. 3, the bearing sleeve 8 has an inner peripheral surface 8a formed with dynamic pressure generating grooves G1 and hill portions (cross-hatched regions) rising radially inward with respect to the dynamic pressure generating grooves G1. In the present embodiment, the dynamic pressure generating grooves G1 arranged in a herringbone pattern are formed at axially adjacent two locations. Specifically, the inner peripheral surface 8a of the sintered body is formed with annular hill portions G2 provided at two locations separated in the axial direction, a plurality of inclined hill portions G3 extending toward both sides in the axial direction from the annular hill portions G2, and the plurality of dynamic pressure generating grooves G1 provided circumferentially between the plurality of inclined hill portions G3. The annular hill portions G2 and the inclined hill portions G3 provided on both sides thereof in the axial direction are continuous with each other, and inner surfaces thereof are arranged on the same cylindrical surface. In the illustrated example, the inclined hill portions G3 provided axially between the pair of annular hill portions G2 are continuous with each other, and inner surfaces thereof are arranged on the same cylindrical surface. In addition, the dynamic pressure generating grooves G1 provided axially between the pair of annular hill portions G2 are continuous with each other, and bottom surfaces thereof are arranged on the same cylindrical surface. The inner peripheral surface 8a of the bearing sleeve 8 is a formed surface formed by pressing a die thereagainst, in the entire area of the inner peripheral surface 8a including the bottom surfaces of the dynamic pressure generating grooves G1, and the inner surfaces of the annular hill portions G2 and the inclined hill portions G3.

An axial groove 8d1 is formed on an outer peripheral surface 8d of the bearing sleeve 8. A radial groove 8b1 and an annular groove 8b2 are formed on the upper end surface 8b of the bearing sleeve 8. A radial groove 8c1 is formed on the lower end surface 8c of the bearing sleeve 8. The annular groove 8b2 is provided to identify the vertical direction and the rotational direction when the bearing sleeve 8 is assembled to the housing 7. The axial groove 8d1 and the radial grooves 8b1, 8c1 form a communication passage that allows a space that the bottom portion 7b of the housing 7 faces to communicate with the atmosphere (see FIG. 2), in the fluid dynamic bearing device 1. Note that any or all of the radial grooves 8b1, 8c1, the annular groove 8b2, and the axial groove 8d1 may be omitted if not particularly necessary.

An inner diameter D1 of the bearing sleeve 8 is, for example, φ 4 mm or less, preferably 2 mm or less, and more preferably φ 1.5 mm or less. An outer diameter D2 of the bearing sleeve 8 is, for example, φ 7 mm or less, and preferably 4 mm or less. A ratio D2/D1 of the outer diameter D2 to the inner diameter D1 of the bearing sleeve 8 is 2.5 or less, preferably 2.0 or less, and more preferably 1.8 or less. An axial dimension L of the bearing sleeve 8 is 4 mm or less, and preferably 3 mm or less.

The relative density (density ratio with respect to the true density) of the bearing sleeve 8 formed of a sintered body is 80 to 95%. The density of the bearing sleeve 8 is substantially uniform in the axial direction. Specifically, if the bearing sleeve 8 is trisected in the axial direction (see the dotted lines in FIG. 3) to form three parts 8A, 8B, 8C, differences in relative density among these parts 8A, 8B, 8C are within 3%, and preferably within 2%. The density of the bearing sleeve 8 is substantially uniform also in the radial direction. Thus, the porosity of the cross section orthogonal to the axial direction of the bearing sleeve 8 is substantially constant in the radial direction. Specifically, in the cross section orthogonal to the axial direction of the bearing sleeve 8, when the porosity (surface opening ratio) is measured at each of three points, that is, a point near the outer peripheral surface 8d, a point at the center in the radial direction, and a point near the inner peripheral surface 8a, the difference among these porosities is 1% or less. Note that the relative density of the bearing sleeve 8 is measured while the bearing sleeve 8 is in a dry state where the inside thereof is not impregnated with oil, according to a method described in JIS Z 2501. The porosity is obtained by taking photographs of portions to be measured, by binarizing the photographs (converting portions other than pore portions into a white color, and converting the pore portions into a black color) through image processing, and by calculating a ratio between the area of the black portions (pores) and the area of the entire visual field. The equipment and photographing conditions adopted for measuring the porosity are as follows.

### Equipment Used

Microscope: Nikon ECLIPSE ME600
Camera head: Nikon DS-Fi2
Photographing software: NIS-Elemenets D
Analysis software: Quick Grain Stand
Exposure adjustment paper: QP card 101

### Photographing Conditions

Exposure time: 10 ms
Analog gain: 1.0×
Measurement magnification: 100 times

The generating line shape (axial cross-sectional shape) of the inner peripheral surface of the bearing sleeve 8 is substantially parallel to the axial direction. Thus, the inner surfaces of the hill portions (the annular hill portions G2 and the inclined hill portions G3) of the inner peripheral surface 8a of the bearing sleeve 8 are arranged in substantially the same cylindrical surface shape. Specifically, the difference between the radius of the smallest diameter portion and the radius of the largest diameter portion of the inner surfaces of the hill portions is within 2 μm, and preferably within 1 μm.

In the fluid dynamic bearing device 1 with the above configuration, when the shaft member 2 rotates, a radial bearing gap is formed between the outer peripheral surface 2a of the shaft member 2 and the inner peripheral surface 8a of the bearing sleeve 8. Then, the dynamic pressure generating grooves G1 formed on the inner peripheral surface 8a of the bearing sleeve 8 cause the pressure of an oil film formed in the radial bearing gap to increase, and with this pressure (dynamic pressure action), a radial bearing portion R configured to support the shaft member 2 in the radial direction is formed. Further, when the convex spherical surface 2b at the lower end of the shaft member 2 is brought into sliding contact with the upper end surface of the thrust plate 10 placed on the bottom portion 7b of the housing 7, a thrust bearing portion T configured to support (contact-support) the shaft member 2 in the thrust direction is formed.

Hereinafter, a method of manufacturing the bearing sleeve 8 will be described.

The bearing sleeve 8 is manufactured through a compaction-molding step, a sintering step, and a sizing step in this order.

In the compaction-molding step, a cylindrical green compact having substantially the same shape as the shape of the bearing sleeve 8 in FIG. 3 is molded by compaction-molding raw material powder containing metal powder as a main raw material. The inner peripheral surface of the green compact has a smooth cylindrical surface shape without unevenness. The axial groove 8d1 is formed on the outer peripheral surface of the green compact, the radial groove 8b1 and the annular groove 8b2 are formed on the upper end surface of the green compact, and the radial groove 8c1 is formed on the lower end surface of the green compact. As the raw material powder, while metal powder (for example, mixed powder of copper powder and iron powder, or copper-iron-based alloy powder) is used as a main raw material, mixed powder is used which is prepared by adding and mixing, to and with the metal powder, various fillers including a molding aid or a solid lubricant.

In the sintering step, the green compact is heated at a predetermined sintering temperature to obtain a sintered body (not illustrated) in which adjacent particles of the metal powder are bonded to each other by solid-phase sintering, liquid-phase sintering, or a combination thereof.

In the sizing step, dynamic pressure generating grooves are die-formed on an inner peripheral surface 28a of a sintered body 28 by using a sizing die 30 illustrated in FIG. 4. Specifically, as illustrated in FIG. 4A, a sizing core 31 is inserted inside the inner periphery of the sintered body 28 with a very narrow gap interposed therebetween, and the width of the sintered body 28 in the axial direction is restrained by using upper and lower punches 32, 33. While maintaining this state, by press-fitting the sintered body 28 inside the inner periphery of a die 34, the sintered body 28 is pressed from both sides in the axial direction and the outer periphery, as illustrated in FIG. 4B. As a result, the inner peripheral surface 28a of the sintered body 28 is pressed against a forming die 31a formed on the outer peripheral surface of the sizing core 31, and then the shape of the forming die 31a is transferred to the inner peripheral surface 28a of the sintered body 28, whereby the dynamic pressure generating grooves G1 and the hill portions G2, G3 (see FIG. 3) are formed.

Thereafter, the sintered body 28, the sizing core 31, and the upper and lower punches 32, 33 are caused to move upward, and the sintered body 28 and the sizing core 31 are taken out from the inner periphery of the die 34. At this time, the inner peripheral surface 28a of the sintered body 28 is enlarged in diameter by springback, and is separated from the forming die 31a on the outer peripheral surface of the sizing core 31. Then, the sizing core 31 is pulled out from the inner periphery of the sintered body 28 (that is, the bearing sleeve 8) whose inner peripheral surface is formed with the dynamic pressure generating grooves G1, the annular hill portions G2, and the inclined hill portions G3.

The sintered body 28 of the present embodiment has a small wall thickness in the radial direction. Specifically, the ratio D2/D1 of the outer diameter D2 to the inner diameter D1 of the sintered body 28 is 2.5 or less. In this case, a compressive force acting radially inward from the die 34 is easily transmitted to the inner peripheral surface of the sintered body 28, and thus it is possible to increase the depth of the dynamic pressure generating grooves G1 formed on the inner peripheral surface of the sintered body 28.

In the present embodiment, the axial dimension L of the sintered body 28 is reduced to 4 mm or less, and thus a compressing force in the axial direction from the upper and lower punches 32, 33 is easily transmittable not only to both axial ends of the sintered body 28 but also to an axially central portion. As a result, the sintered body 28 can be uniformly pressed in the axial direction, and thus the density of the sintered body 28 can be made uniform in the axial direction. Therefore, it is possible to make uniform the depths of the dynamic pressure generating grooves G1, formed on the inner peripheral surface of the sintered body 28, in the axial direction, and it is possible to reduce disturbance in the generating line shape of the inner peripheral surface of the sintered body 28.

The internal pores of the bearing sleeve 8 manufactured through the above procedure are impregnated with lubricating oil by a technique such as vacuum impregnation. After the bearing sleeve 8 and the sealing member 9 are fixed inside the inner periphery of the housing 7, a predetermined amount of lubricating oil is injected, and then the shaft member 2 is inserted inside the inner periphery of the bearing sleeve 8, whereby the fluid dynamic bearing device 1 is completed.

The present invention is not limited to the above embodiment. Hereinafter, another embodiment of the present invention will be described, and description of the same points as those of the above embodiment will be omitted.

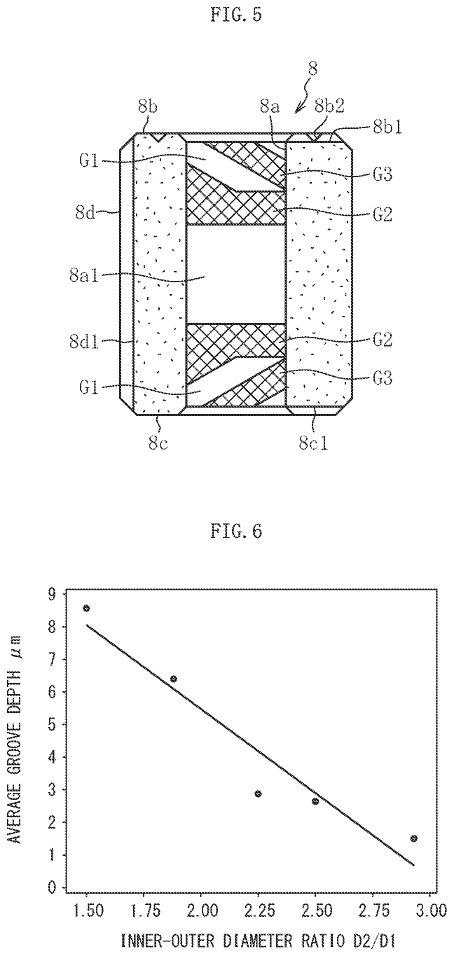

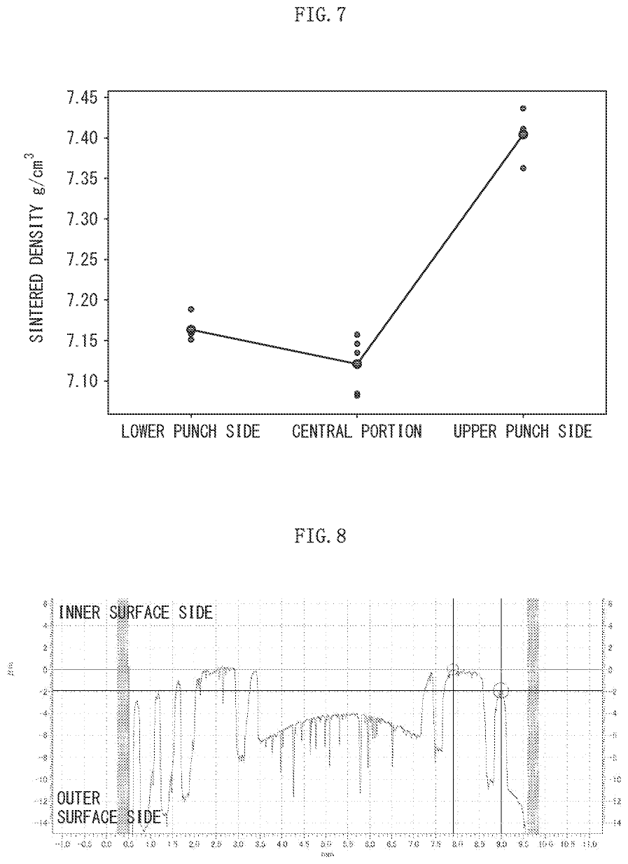

The bearing sleeve 8 illustrated in FIG. 5 is different from the bearing sleeve 8 of the above embodiment in that the dynamic pressure generating grooves G1 and the inclined hill portions G3 provided axially between the pair of annular hill portions G2 are omitted. In the bearing sleeve 8, the entire area axially between the pair of annular hill portions G2 is formed with a cylindrical surface 8a1, in the inner peripheral surface 8a. The inner diameter of the cylindrical surface 8a1 is larger than each of the respective inner diameters of the annular hill portions G2, and is continuously provided on the same cylindrical surface as that of the bottom surfaces of the dynamic pressure generating grooves G1, for example. In the sizing step (see FIG. 4), the compressing force in the axial direction from the upper and lower punches 32, 33 is less likely to be transmitted to the center of the sintered body 28 in the axial direction. Thus, even if the axial dimension of the sintered body 28 is reduced, the density at the center of the sintered body 28 in the axial direction is slightly lower than the density at both axial ends. Therefore, by omitting the dynamic pressure generating grooves G1 and the inclined hill portions G3 within the axially central portion having a relatively low density, it is possible, although reduction in dynamic pressure action occurs, to reduce variation in the dynamic pressure generating groove depth for each product, that is, variation in bearing rigidity for each product, so that it is possible to enhance reliability of the product.

The fluid dynamic bearing according to the present invention is not limited to an oil-impregnated sintered bearing that is impregnated with lubricating oil, as described above, and can be used even in a dry state where the bearing is not impregnated with lubricating oil. The fluid dynamic bearing device 1 is not limited to use in the fan motor, and can be used for a spindle motor of a disk drive device of an HDD or a polygon scanner motor of a laser beam printer.

### REFERENCE SIGNS LIST

1 Fluid dynamic bearing device
2 Shaft member
7 Housing
8 Bearing sleeve (fluid dynamic bearing)
8A, 8B, 8C Three parts
8a1 Cylindrical surface
28 Sintered body
30 Sizing die
31 Sizing core
32, 33 Upper and lower punches
34 Die
G1 Dynamic pressure generating groove
G2 Annular hill portion
G3 Inclined hill portion
R Radial bearing portion
T Thrust bearing portion

1. A fluid dynamic bearing comprising:
a sintered body having a cylindrical shape, the sintered body being formed with dynamic pressure generating grooves on an inner peripheral surface of the sintered body, wherein
a ratio D2/D1 of an outer diameter D2 to an inner diameter D1 of the sintered body is 2.5 or less, and
differences in relative density among three parts defined by axially trisecting the sintered body are within 3%.

2. The fluid dynamic bearing according to claim 1, wherein an axial length of the sintered body is 4 mm or less.

3. The fluid dynamic bearing according to claim 1, wherein the sintered body comprises a hill portion rising radially inward with respect to the dynamic pressure generating grooves,
and wherein a difference between a radius of a smallest diameter portion and a radius of a largest diameter portion of an inner surface of the hill portion on the inner peripheral surface of the sintered body is 2 μm or less.

4. The fluid dynamic bearing according to any one of claims 1 to 3, wherein the inner peripheral surface of the sintered body is formed with:
a pair of annular hill portions provided at two locations axially separated from each other;
a plurality of inclined hill portions extending axially outward from the annular hill portions;
the dynamic pressure generating grooves provided circumferentially between the plurality of inclined hill portions; and
a cylindrical surface provided in an entire area axially between the pair of annular hill portions, the cylindrical surface having a diameter larger than each of respective inner diameters of the annular hill portions.

5. A fluid dynamic bearing device comprising:
the fluid dynamic bearing according to any one of claims 1 to 4;
a shaft member inserted inside an inner periphery of the fluid dynamic bearing; and
a radial bearing portion configured to support the shaft member in a non-contact manner to allow the shaft member to be relatively rotatable, with dynamic pressure action of a lubricating film formed in a radial bearing gap between an inner peripheral surface of the fluid dynamic bearing and the shaft member.
